(19) United States
(12) Patent Application Publication
(10) Pub. No.: US 2005/0286570 A1
(43) Pub. Date: Dec. 29, 2005

(54) Tunable laser with a concave diffraction grating

(76) Inventor: Lian-Qin Xiang, Acton, MA (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/881,031

(22) Filed: Jun. 29, 2004

(51) Int. Cl. H01S 3/10

(52) U.S. Cl. 372/20; 372/102

(57) ABSTRACT

A tunable laser including an optical gain medium, a diffraction grating, and a tuning mechanism. In general, the optical gain medium is configured to emit a light beam from a front facet and a laser beam from a rear facet. The diffraction grating includes a concave reflective diffractive surface positioned to receive the light beam, and is configured to reflect light of a selected wavelength to the front facet of the optical gain medium. The tuning mechanism is configured to adjust the relative position of the optical gain medium and the diffraction grating.

### BACKGROUND

Lasers have become commonplace in the modem world. Compact disks (CDs) are widely used for entertainment and business, and digital versatile disks (DVDs) are widely used for entertainment. Industrial and scientific uses for lasers include high-resolution spectroscopic analysis, and are commonly implemented in a vast variety of optical sensor systems. Optical communication systems routinely utilize lasers to generate light beams for communicating optical signals.

The process of light amplification by stimulated emission of radiation (LASER) occurs in an optical resonator. The components of a typical optical resonator include: a partially reflective mirror from which the useful portion of the laser beam is emitted; an optical amplifier such as a glass tube filled with an appropriate gas, or a semiconductor device; and a reflective mirror. The laser beam is formed by light resonating between the mirrors located at the two ends of the optical resonator.

Some applications require a laser to emit a beam that can be tuned to different wavelengths. Such applications include, among others: devices that read and write CDs or DVDs by altering the laser beam between a write wavelength and a read wavelength; spectroscopic analysis of a substance using various wavelengths of light; and optical communication systems that utilize wavelength division multiplexing (WDM).

Each of the optical components used in a tunable laser must be precisely manufactured, placed into exact alignment relative to one another, and this alignment must be maintained in order for the laser to properly function. In some situations it is desirable to minimize the number of optical components in an effort to achieve a desired cost target while maintaining an acceptable reliability standard.

### SUMMARY OF THE INVENTION

In accordance with some embodiments of the invention, a tunable laser includes an optical gain medium, a diffraction grating, and a tuning mechanism. The optical gain medium is configured to emit a light beam from a front facet and a laser beam from a rear facet. The diffraction grating includes a concave reflective diffractive surface positioned to receive the light beam, and is configured to reflect light of a selected wavelength to the front facet of the optical gain medium. The tuning mechanism is configured to adjust the relative position of the optical gain medium and the diffraction grating.

### BRIEF DESCRIPTION OF THE DRAWING

The above and other aspects, features, and advantages of the present invention will become more apparent upon consideration of the following description of preferred embodiments taken in conjunction with the accompanying drawing figures, wherein:

FIG. 1 is a schematic side view showing the components of an exemplary laser in accordance with one embodiment of the invention;

FIG. 2A is a side view of an exemplary diffraction grating that may be used with the laser depicted in FIG. 1;

FIG. 2B is a cross-sectional view of a diffraction grating taken along line 2B-2B of FIG. 2C;

FIG. 2C is a top view of the diffraction grating of FIGS. 2A and 2B;

FIG. 2D shows an enlarged partial cross-sectional view of the diffraction surface of the diffraction grating of FIGS. 2A-2C;

FIGS. 3A-3D show various enlarged cross-sectional views of groove profiles of a diffraction grating that may be used with the laser depicted in FIG. 1;

FIG. 4 is a block diagram showing system components for fabricating the diffraction grating of FIGS. 2A-2D; and

FIG. 5 is a flowchart showing exemplary operations for generating a lasing light beam in accordance with embodiments of the invention.

### DETAILED DESCRIPTION OF PREFERRED EMBODIMENTS

In the following detailed description, reference is made to the accompanying drawing figures which form a part hereof, and which show by way of illustration specific embodiments of the invention. Other embodiments may be utilized, and structural, electrical, as well as procedural changes may be made without departing from the scope of the present invention.

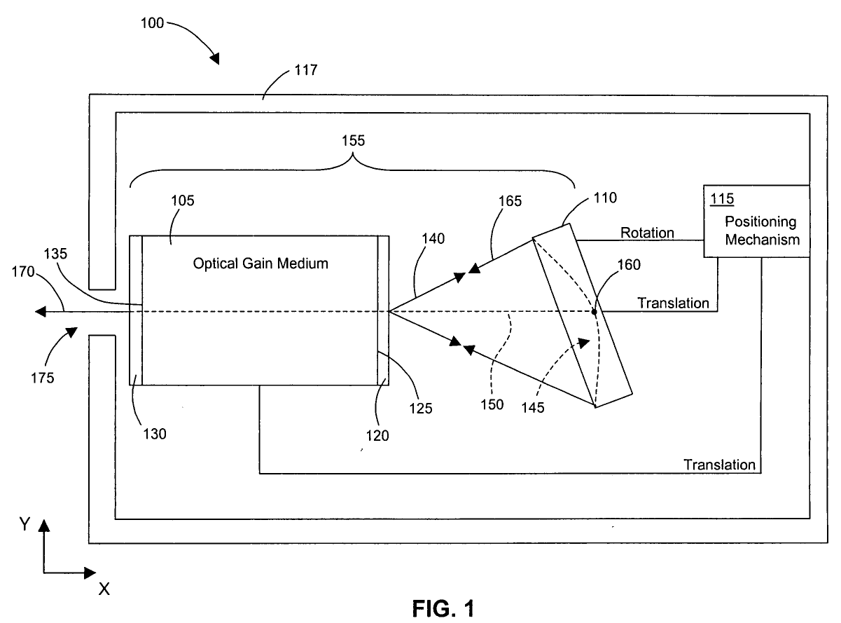

FIG. 1 is a diagram showing the components of exemplary laser 100 in accordance with one embodiment of the invention. In general, laser 100 includes optical gain medium 105, diffraction grating 110, and a positioning mechanism shown schematically at 115. The positioning mechanism is shown attached to housing 117 and is coupled to the diffraction grating and the optical gain medium.

Gain medium 105 may be implemented using known devices for amplifying light including, for example, a semiconductor diode, and plasma-based or liquid-based optical media. The gain medium is shown having an anti-reflection (AR) layer 120 on front facet 125, and a reflective or partially reflective layer 130 on rear facet 135.

Gain medium 105 emits light beam 140 which propagates along optical axis 150. Light beam 140 is a diverging light beam which is incident upon diffraction surface 145 of diffraction grating 110. Resonant cavity 155 is defined by rear facet 135 and the diffraction surface of grating 110.

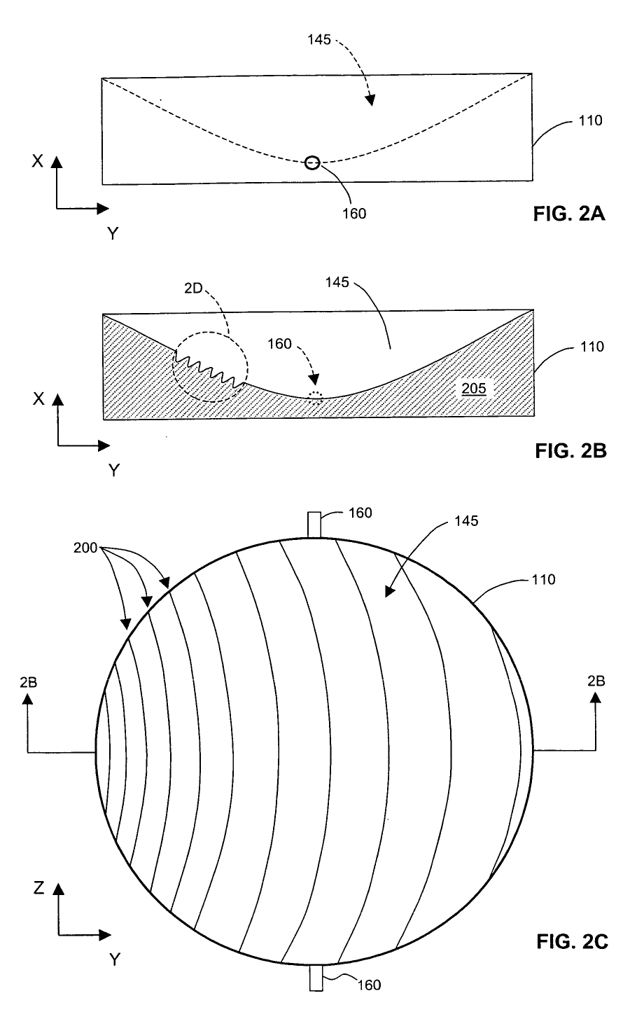

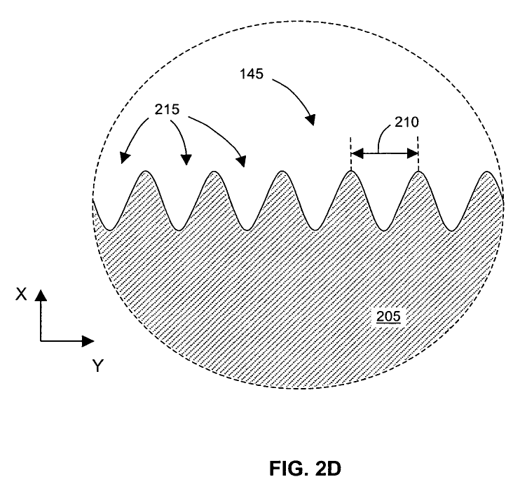

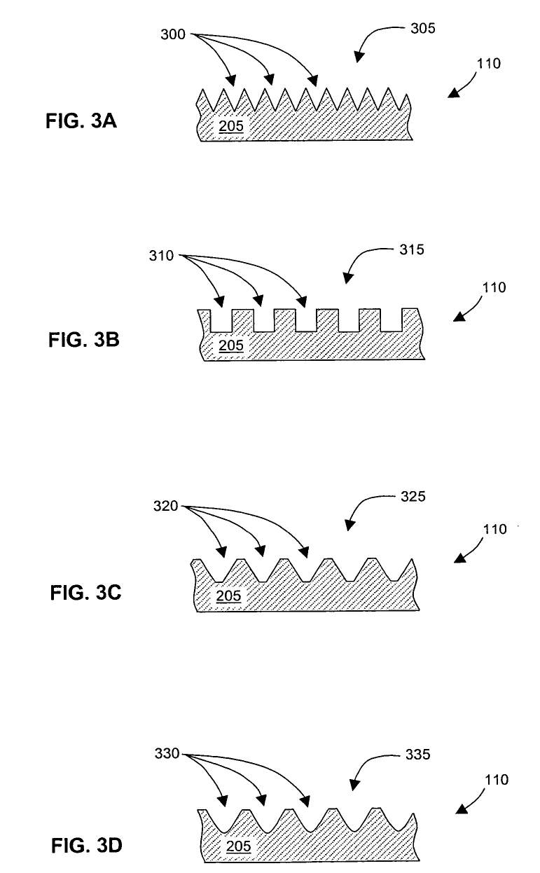

Reflective diffraction surface 145 is concave with respect to incident light beam 140. Diffraction grating 110 may be implemented using a conventional reflective diffraction grating. Diffraction grating 110 diffracts and thereby focuses a diverging light beam that is incident upon the grating. The concave diffraction grating may have either a spherical diffraction surface or an aspherical diffraction surface. Particular examples of aspherical diffraction surfaces include parabolic and elliptical surfaces. In addition, a suitable diffraction grating has a diffraction efficiency anywhere from about 30 percent to about 93 percent. Examples of various types of conventional diffraction grating configurations that may be used in laser 100 are depicted in FIGS. 2A-2D, and 3A-3D, and will be described in more detail in conjunction with these figures.

Referring again to FIG. 1, the diffraction grating 110 is shown having optional pivot pin 160, which is located on the diameter mid-point of the diffraction grating, coinciding with the apex of diffraction surface 145 (shown in dashed lines). Optimally, the pivot pin is located on optical axis 150, which is the propagation axis of light beam 140. As will be described in more detail below, laser 100 is tuned by adjusting the relative position of diffraction grating 110 and gain medium 105 using a tuning device such as positioning mechanism 115.

In operation, gain medium 105 emits diverging light beam 140 which propagates along optical axis 150 toward diffraction grating 110. Diffraction surface 145 diffracts light of a selected wavelength, shown in FIG. 1 as diffracted light beam 165, back along a reciprocal path to optical gain medium 105. The concave shape and reflective properties of the diffraction surface of the grating cause diffracted light beam 165 to retrace the optical path of incident light beam 140. The diffracted light beam enters front facet 125, passes through optical gain medium 105, and is reflected at reflective layer 130. Stimulated emission is caused by the diffracted light beam retracing the path of light beam 140. This results in the generation of laser light beam 170, which is shown propagating from housing 117 via aperture 175.

The concave shape of diffraction surface 145 enables the diffraction grating to reflect the diverging light beam emitted by front facet 125 of the optical gain medium back to the front facet of the optical gain medium as a converging light beam that enters the optical gain medium without the need for any additional imaging components such as a lens or lens and mirror combination. This is not to say that a lens would never be employed in this structure. There may be special circumstances where a lens could provide an enhanced result.

The wavelength selected by the diffraction grating, and thus the wavelength of laser light beam 170, is tuned by adjusting the relative positions of optical medium 105 and diffraction grating 110. Such adjustment of the relative positions changes the incidence angle of light beam 140 with respect to the reflective diffraction grating 110, which changes the selected wavelength. Such adjustment of the relative positions typically additionally changes the length of resonant cavity 155 to ensure that the cavity remains resonant at the changed selected wavelength. Possible adjustments of the relative positions of optical gain medium 105 and diffraction grating 110 include: rotating the diffraction grating about pivot pin 160; translating the diffraction grating along the X axis; translating the diffraction grating along the Y axis; or some combination thereof. Alternatively or additionally, the relative position of the gain medium and the diffraction grating may be adjusted by translating the gain medium along the X axis, the Y axis, or both axes. One specific example is to rotate the diffraction grating about the pivot pin, and to translate the diffraction grating along the X axis relative to the optical gain medium.

The optical resonance process implemented by laser 100 may be summarized as: amplifying light in gain medium 105, emitting light beam 140 from the gain medium, reciprocally reflecting the light beam at a selected wavelength at the diffraction surface of grating 110, and emitting a portion of the amplified light as laser light beam 170. This resonance process is advantageously simple compared to conventional designs for tunable lasers that often require the cavity laser beam to be imaged by a separate lens or some sort of lens, grating, and mirror combination.

Each optical component within a laser unavoidably disperses, absorbs or otherwise dissipates some of the light. However, since laser 100 has fewer components than traditional lasers, the amount of light that is lost is reduced. A reduction in the amount of dissipated light provides one or more of the following benefits: it increases the light output of the laser, permits the laser to be operated with less power, and increases the range of wavelengths in which the laser can effectively operate.

In one embodiment of the invention, adjustment of the relative position of gain medium 105 and diffraction grating 110 is performed infrequently. For example, adjustment may occur during an initial calibration process after the laser is manufactured and then re-occur only infrequently, if at all, during maintenance or repair operations in the field. Such an embodiment can use a positioning mechanism having a threaded rod that engages the diffraction grating. In this embodiment, the diffraction grating is adjusted (rotated, translated relative to the optical gain medium, or both) by rotating the rod, possibly manually, or by means of a stepper motor or the like.

In an alternative embodiment, the adjustment of the relative position of the gain medium and diffraction grating occurs dynamically during the operation of the laser. This may be accomplished using, for example, the just-described threaded rod adjustment mechanism under the control of an electronic position-control circuit that receives feedback as to the wavelength currently being emitted by the laser.

FIGS. 2A-2D show various views of a diffraction grating that forms part of laser 100. FIGS. 2A and 2C respectively show side and top views of diffraction grating 110, and FIG. 2B is a cross-sectional view of the diffraction grating taken along line 2B-2B of FIG. 2C. FIG. 2D shows a partial enlarged cross-sectional view of diffraction surface 145 of the diffraction grating of FIGS. 2A-2C.

As shown in these figures, the basic shape of reflective diffraction surface 145 is concave and is defined by a series of diffraction grooves 200. FIGS. 2A and 2B show diffraction grating 110 composed of substrate 205, in which diffraction surface 145 is formed. The substrate may be formed of any suitably rigid material in which the appropriate diffraction grooves may be formed in or on. Suitable materials include aluminum, silicon, silica, glass, plastic, and the like. A particular example of a glass product that may be used for substrate 205 is ultra low expansion (ULE) glass manufactured by Corning, Inc., of Corning, N.Y.

Astigmatism defines the condition in which the tangential and sagittal foci of a diffraction grating are not coincident, which causes a line image at the tangential focus. A diffraction grating with diffraction grooves that are uniform and parallel typically causes a diffracted light beam to have a large amount of astigmatism. As a result, light beams diffracted by such gratings result in undesirable line images. As a line image propagates, it becomes increasingly more difficult to focus the image on a desired optical element, such as front facet 125 of gain medium 105. Accordingly, in accordance with embodiments of the invention, diffraction surface 145 includes diffraction grooves 200 that have increasing pitch and curvature radius which enables the grating to correct astigmatism in incident light beam 140 and diffracted light beam 165.

In general, diffraction grooves have particular characteristics such as pitch, curvature, and profile. Groove pitch 210 (FIG. 2D) is the distance between adjacent peaks, or equivalently, the distance between the centers of adjacent grooves. Groove pitch is typically non-uniform across the entire diffraction grating. In the embodiment of FIG. 2C, the pitch of the diffraction grooves increases non-linearly as the distance along the Y axis increases. This figure also shows that each diffraction groove has an increasing radius of curvature as the distance along the Y axis increases. The pitch and radius of curvature of the diffraction grooves increase in a direction non-parallel to the direction of an incident light beam. Diffraction grooves 200, which form diffraction surface 145, generally have the same profile over the entire surface of the grating. FIG. 2D shows an example of diffraction surface 145 in which diffraction grooves have a sinusoidal profile.

Used in a tunable laser, an astigmatism-correcting diffraction grating advantageously increases the tuning range of the wavelengths of the beam that the laser can emit, or increases the efficiency with which the laser operates, or both. The specifics regarding the particular pitch and curvature radii of the various diffraction grooves that will correct astigmatism is known. See, for example, “Diffraction Gratings,” pages 222-227, by M. C. Huntly, 1982, Academic Press, and “Diffraction Gratings and Applications,” pages 255-275, by Evgeny Popov and Erwing G. Loewen, 1997, Marcel Dekker.

Diffraction grating 110 is shown as a circular diffraction grating, but other geometries (for example, elliptical, rectangular, and the like) may also be used. In addition, a diffraction grating having diffraction grooves with a sinusoidal groove profile is depicted in FIGS. 2B and 2D, but many other groove profiles are possible. For example, FIG. 3A shows a partial cross-sectional view of diffraction grating 110 in which diffraction surface 305 is composed of V-shaped diffraction grooves 300. In FIG. 3B, diffraction surface 315 has rectangular diffraction grooves 310 in which each groove has a sharply rising surface followed by a top surface, followed by a sharply falling surface, followed by a bottom surface.

FIG. 3C shows diffraction surface 325 having diffraction grooves 320 defined by a surface that rises at an acute angle relative to the plane of the diffraction surface, followed by a top surface, followed by a surface that falls at an acute angle relative to the plane of the diffraction surface, followed by a bottom surface. FIG. 3D shows diffraction surface 335 having truncated sinusoidal diffraction grooves 330. Other profile possibilities include tilting the profile of a sinusoidal diffraction surface, changing the angles along the surface of a groove, changing the sizes of the surfaces of a groove, changing curvature parameters of the groove, and implementing various types of groove shapes in a single grating.

Each diffraction groove profile will exhibit a particular diffraction efficiency. Accordingly, the selection of a particular groove profile for the diffraction grating is typically determined by the diffraction efficiency requirements of the laser application being implemented.

The grooves of the diffraction surface may be formed using any suitable technique. For example, angular grooves can be formed by passing a diamond-tipped scribe over the surface of a diffraction grating, or by using conventional ion-beam milling technology. Photolithography is another well-known technique that may be used to form the grooves of the diffraction grating.

Using a diffraction grating that has diffraction grooves with increasing pitch and radius curvature is helpful in many applications, as noted above, but such a diffraction grating is not an essential feature of the present invention. Diffraction gratings having diffraction grooves that are uniform and parallel may also be used.

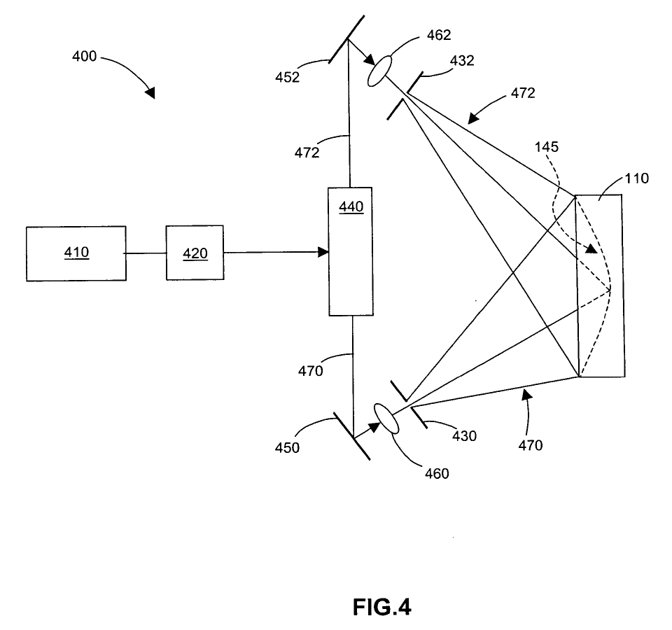

FIG. 4 is a block diagram showing diffraction grating fabrication system 400. The system generally includes laser 410, beam expander 420, and beam splitter 440. Mirrors 450 and 452 are associated with imaging components 460 and 462, respectively. This system will be described in connection with forming diffraction grating 110 of FIGS. 2A-2D, for example.

In operation, laser 410 generates an exposure beam that is expanded by beam expander 420. The exposure beam enters beam splitter 440 where the beam is split into two exposure beams, 470 and 472. Exposure beams 470 and 472 are reflected by mirrors 450 and 452, respectively. Imaging components 460 and 462 respectively direct exposure beams 470 and 472 through spatial filters 430 and 432 onto surface 145 of diffraction grating 110. This optical configuration causes exposure beams 470 and 472 to overlap and interfere with each other, according to the well-known principles of light wave interference and holography.

The interference pattern formed by exposure beams 470 and 472 can be modified by changing the position of spatial filters 430 and 432 relative to diffraction grating 110, or by changing the incidence angle of exposure beams 470 and 472. A change in the interference pattern results in a corresponding change in the groove pitch, or the radius of curvature of the diffraction grooves, or both. As previously described, the amount of astigmatism and other aberration correction provided by the diffraction grating depends upon the pitch and curvature radii of the various diffraction grooves of the grating. Accordingly, a diffraction grating that can correct a particular level or type of aberration may be formed by changing the position of spatial filters 430 and 432, or the incidence angle of exposure beams 470 and 472, or both.

Concave surface 145 is coated with a suitable positive or negative photoresist. When exposed to the interference pattern produced by exposure beams 470 and 472, the photoresist records the interference pattern. A suitable positive photoresist development process, for example, removes portions of the photoresist that were exposed to the interference pattern, leaving portions of the photoresist that were not exposed to the interference pattern. To form a reflective diffraction grating, a reflective metal layer, for example, may be formed over the patterned surface using known deposition techniques.

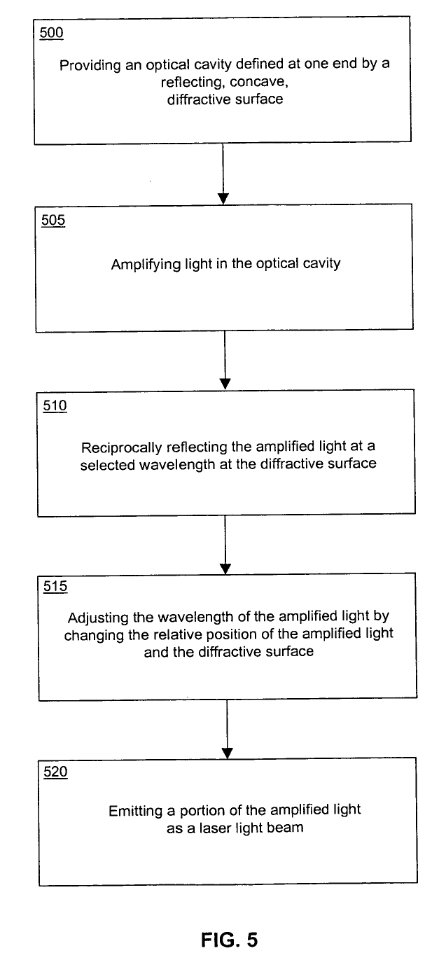

FIG. 5 is a flowchart showing exemplary operations for generating a laser light beam according to some embodiments of the invention. At block 500, an optical cavity is provided. This optical cavity is defined at one end by a reflecting concave diffractive surface. In block 505, light is amplified in the optical cavity. In block 510, the amplified light at a selected wavelength is reciprocally reflected at the diffractive surface. In block 515 the wavelength of the amplified light is adjusted by changing the relative positioning of the amplified light and the diffractive surface. In block 520 a portion of the amplified light is emitted as the laser light beam.

While the invention has been described in detail with reference to disclosed embodiments, various modifications within the scope of the invention will be apparent. It is to be appreciated that features described with respect to one embodiment typically may be applied to other embodiments. Therefore, the invention properly is to be construed only with reference to the claims.

1. A tunable laser, comprising:
an optical gain medium comprising a front facet and a rear facet, said optical gain medium configured to emit a light beam from said front facet and a laser beam from said rear facet;
a diffraction grating comprising a concave reflective diffractive surface positioned to receive said light beam, said diffraction grating reciprocally reflecting light of a selected wavelength to said front facet of said optical gain medium; and
a tuning mechanism configured to adjust relative positioning between said optical gain medium and said diffraction grating.

2. The laser according to claim 1, wherein said diffractive surface comprises diffraction grooves having pitch and radius of curvature that increase in a direction non-parallel to the direction of said light beam.

3. The laser according to claim 1, wherein said tuning mechanism is configured to rotate said diffraction grating about a pivot.

4. The laser according to claim 1, wherein said tuning mechanism is configured to translate said diffraction grating relative to said optical gain medium.

5. The laser according to claim 1, wherein said tuning mechanism is configured to rotate said diffraction grating about a pivot and to translate said diffraction grating relative to said optical gain medium.

6. The laser according to claim 1, wherein said tuning mechanism is configured to translate said optical gain medium relative to said diffraction grating.

7. The laser according to claim 1, wherein said front facet includes anti-reflection material.

8. The laser according to claim 1, wherein said rear facet is partially reflective.

9. A method for generating a laser light beam, said method comprising:
providing an optical cavity defined at one end by a reflecting, concave, diffractive surface;
amplifying light in said cavity;
reciprocally reflecting said amplified light at a selected wavelength at said diffractive surface;
adjusting said wavelength of said amplified light by changing relative positioning of said amplified light and said diffractive surface; and
emitting a portion of said amplified light as said laser light beam.

10. The method according to claim 9, additionally comprising:
configuring said diffractive surface to correct astigmatism in said amplified light.

11. The method according to claim 10, in which:
the diffractive surface comprises diffraction grooves formed therein, said grooves having a pitch and a radius of curvature; and
said configuring comprises increasing said pitch and said radius of curvature of said groves in a direction non-parallel to the direction of said amplified light.

12. The method according to claim 9, in which said adjusting comprises rotating said diffractive surface relative to said amplified light.

13. The method according to claim 9, in which said adjusting comprises translating said diffractive surface relative to said amplified light.

14. The method according to claim 9, in which said adjusting comprises rotating said diffractive surface and translating said diffractive surface relative to said amplified light.

15. The method according to claim 9, in which said adjusting comprises translating said amplified light relative to said diffractive surface.

16. A tunable laser, comprising:
an optical gain medium comprising a front facet and a rear facet, said optical gain medium configured to emit a light beam from said front facet and a laser beam from said rear facet;
diffraction means for diffracting and reciprocally reflecting said light beam as a converging light beam that enters said front facet of said optical gain medium, said converging light beam having a wavelength selected by said diffraction means; and
a tuning mechanism configured to adjust relative positioning between said optical gain medium and said diffraction means.

17. The laser according to claim 16, wherein said diffraction means comprises diffraction grooves having pitch and radius of curvature that increase in a direction non-parallel to the direction of said light beam.

18. The laser according to claim 16, wherein said tuning mechanism is configured to rotate said diffraction means about a pivot.

19. The laser according to claim 16, wherein said tuning mechanism is configured to translate said diffraction means relative to said optical gain medium.

20. The laser according to claim 16, wherein said tuning mechanism is configured to translate said optical gain medium relative to said diffraction means.

21. The laser according to claim 16, wherein said front facet includes anti-reflection material.

22. The laser according to claim 16, wherein said rear facet is partially reflective.
